(19) United States
(12) Patent Application Publication
(10) Pub. No.: US 2024/0177476 A1
(43) Pub. Date: May 30, 2024

(54) OBJECT DETECTION SYSTEM AND METHOD

(71) Applicant: Fujitsu Limited, Kawasaki-shi (JP)

(72) Inventor: Kohji YAMADA, Kawasaki (JP)

(73) Assignee: Fujitsu Limited, Kawasaki-shi (JP)

(21) Appl. No.: 18/241,258

(22) Filed: Sep. 1, 2023

(30) Foreign Application Priority Data
Nov. 24, 2022 (JP) 2022-187576

(51) Int. Cl. G06V 10/94; G06V 10/26; G06V 10/44; G06V 10/77; G06V 10/82

(52) U.S. Cl. CPC G06V 10/95; G06V 10/267; G06V 10/449; G06V 10/7715; G06V 10/82

(57) ABSTRACT

An object-detection system configured to form an object-detection model generated by machine learning to detect an object from an image, the object-detection system includes an edge computer configured to extract a feature from a reduced image in which an input image is reduced to a predetermined size, and compress and transmit the feature, and a server configured to decode the feature, and perform object-detection for each of divided features into which the feature is divided in association with respective divided images into which the reduced image is divided with overlapping regions in a first size, the divided features including a second size that depends on a division position in the object-detection model, wherein the predetermined size is determined based on the first size of the overlapping regions and the second size of the divided features, and wherein the object-detection model is divided into the edge computer and the server.

### CROSS-REFERENCE TO RELATED APPLICATION

This application is based upon and claims the benefit of priority of the prior Japanese Patent Application No. 2022-187576, filed on Nov. 24, 2022, the entire contents of which are incorporated herein by reference.

### FIELD

The technique disclosed herein relates to an object detection system and an object detection method.

### BACKGROUND

Object detection using an object detection model generated by deep learning using a huge volume of image data is able to achieve higher detection accuracy than object detection using features created by a person does. The object detection by deep learning has started to be applied to, for example, a system such as a video monitoring system for detecting a suspicious person or the like from an image captured by a monitoring camera. Along with enhancement of the resolutions of cameras such as high definition (HD) and 4K, high-resolution cameras have started to be adopted also for the object detection by deep learning in the aforementioned video monitoring system or the like. As a result, object detection by deep learning is currently performed on high-resolution images.

In the case of using a high-resolution image in object detection by deep learning, there is a method for detecting, for example, a small object in the image by detecting the object from divided images into which the high-resolution image is divided or a reduced image to which the high-resolution image is reduced.

For example, there has been proposed a pupil region detection device which detects a pupil region of a subject from a digital image. This device performs processing of reducing a digital image into a reduced digital image, calculates a feature in the reduced digital image, and detects a pupil region in the digital image based on the calculated feature in the reduced digital image.

For example, there has been proposed an image processing device which divides an input image to output multiple divided images, and performs computation of an object detection model by giving each of the divided images as an input to the object detection model. This device acquires, as metadata of each divided image, an attribute information set including an attribute value of an object included in the divided image and a quadrangular frame surrounding the object. This device outputs an overall image to which the input image is reduced, and performs computation of the object detection model by giving the overall image as an input to the object detection model. This device acquires, as metadata of the overall image, an attribute information set including an attribute value of an object included in the overall image and its quadrangular frame. This device generates metadata of the input image by combining the attribute information set of the metadata of the divided image and the attribute information set not held in common in the metadata of the overall image and the metadata of the divided image.

Japanese Laid-open Patent Publication No. 2006-350426 and International Publication Pamphlet No. WO 2021/161513 are disclosed as related art.

### SUMMARY

According to an aspect of the embodiments, an object detection system configured to form an object detection model generated by machine learning to detect an object from an image, the object detection system includes an edge computer configured to extract a feature from a reduced image in which an input image is reduced to a predetermined size, and compress and transmit the feature, and a server configured to decode the feature, and perform object detection for each of divided features into which the feature is divided in association with respective divided images into which the reduced image is divided with overlapping regions in a first size, the divided features including a second size that depends on a division position in the object detection model, wherein the predetermined size is determined based on the first size of the overlapping regions and the second size of the divided features, and wherein the object detection model is divided into the edge computer and the server.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a network structure of a YOLOv3;

FIG. 2 is a diagram for explaining object detection from a reduced image in YOLOv3;

FIG. 3 is a diagram for explaining object detection from divided images in YOLOv3;

FIG. 4 is a diagram for explaining a problem of object detection from divided images;

FIG. 5 is a diagram for explaining an image feature compression transmission technique;

FIG. 6 is a block diagram illustrating a configuration of a reference example;

FIG. 7 is a functional block diagram of an object detection system according to a first embodiment;

FIG. 8 is a diagram for explaining a division position of an object detection model;

FIG. 9 is a diagram for explaining processing in the first embodiment;

FIG. 10 is a block diagram illustrating a schematic configuration of a computer functioning as an edge;

FIG. 11 is a block diagram illustrating a schematic configuration of a computer functioning as a server;

FIG. 12 is a flowchart illustrating an example of extraction processing according to the first embodiment;

FIG. 13 is a flowchart illustrating an example of detection processing according to the first embodiment;

FIG. 14 is a functional block diagram of an object detection system according to a second embodiment;

FIG. 15 is a diagram for explaining processing in the second embodiment;

FIG. 16 is a flowchart illustrating an example of extraction processing according to the second embodiment; and

FIG. 17 is a flowchart illustrating an example of detection processing according to the second embodiment.

### DESCRIPTION OF EMBODIMENTS

In the case of detecting an object from divided images into which a high-resolution image is divided, an overlapping region is provided to a division boundary in some cases in order to avoid occurrence of non-detection or erroneous detection at the division boundary. In this case, since the size of each divided image increases by the overlapping region thus added, there is a problem of increasing a processing load for extracting a feature from the divided image. In another case, an object detection model is divided and arranged in an edge computer and a server, and the edge computer extracts a feature from an image. Since the processing capacity of the edge computer is lower than that of the server, an increase in the processing load for extracting the feature from the divided image leads to a decrease in the frame rate of the entire object detection processing.

Hereinafter, embodiments according to techniques capable to reduce a processing load on an edge computer for extracting a feature from an image will be described below with reference to the drawings.

First, before describing the details of the present embodiments, a technique as a basis for the present embodiments and problems of the technique will be described.

The present embodiments are based on object detection by deep learning such, for example, as region-based convolutional neural network (R-CNN), you only look once (YOLO), and single shot multibox detector (SSD). For example, the present embodiments relate to a method of performing object detection by dividing a high-resolution image in order to detect a small object in the image.

For example, YOLOv3 uses, as an input image, an image having an aspect ratio of 1:1 in which each of the vertical and horizontal lengths is within 320 to 608 pixels and is a multiple of 32 [320, 352, 384, 416, 448, 480, 512, 544, 576, 608]. YOLOv3 obtains, as detection results, a type and a reliability score of a detected object, and the position of the object in the image such as the upper left and lower right coordinates of a bounding box surrounding the detected object.

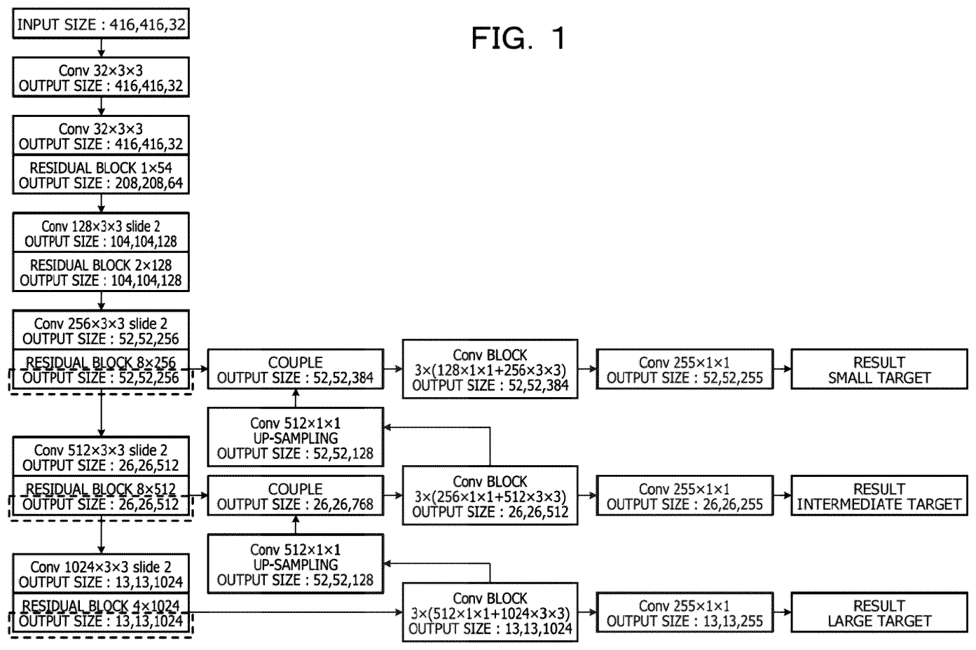

FIG. 1 illustrates an example of a network structure in YOLOv3. YOLOv3 is enabled to detect objects different in size by performing detection processing with dividing an input image into three sizes of 13×13 pixels, 26×26 pixels, and 52×52 pixels indicated in broken line portions in FIG. 1. Accordingly, there is a possibility that YOLO fails to detect an object larger or smaller than the three sizes applied to the machine learning of YOLOv3.

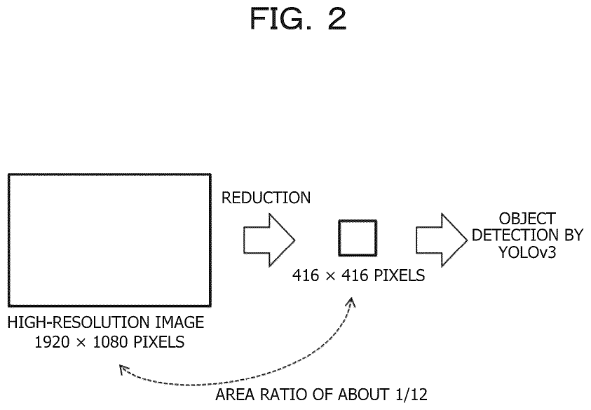

The resolution of an image input to YOLOv3 is 320×320 pixels to 608×608 pixels as described above. For this reason, in the case of object detection from the overall image of an image with a high-resolution image such as HD or 4K, the image is reduced and then the objection detection is performed as illustrated in FIG. 2. In the example illustrated in FIG. 2, a high-resolution image of 1920×1080 pixels is reduced to 416×416 pixels, and the reduced image reduced to about 1/12 in area ratio is input to YOLOv3. In the case of object detection from a reduced image, there is a possibility that YOLO fails to detect a small object in the image because the small image is made much smaller by the reduction processing.

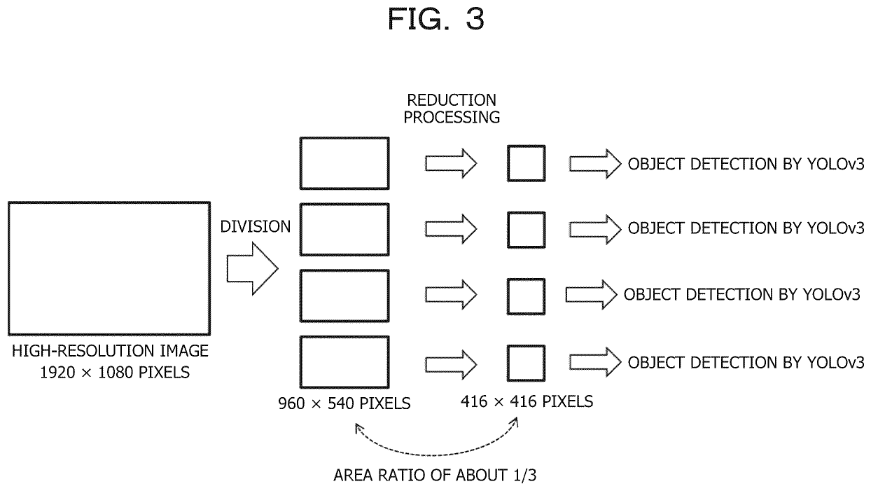

In order to avoid making an object too small, object detection is performed on each of divided images into which a high-resolution image is divided as illustrated in FIG. 3. In the example illustrated in FIG. 3, each of four divided images of 960×540 pixels of an image of 1920×1080 pixels is reduced to 416×416 pixels, and the four reduced images each reduced to about 1/3 in area ratio are input to YOLOv3.

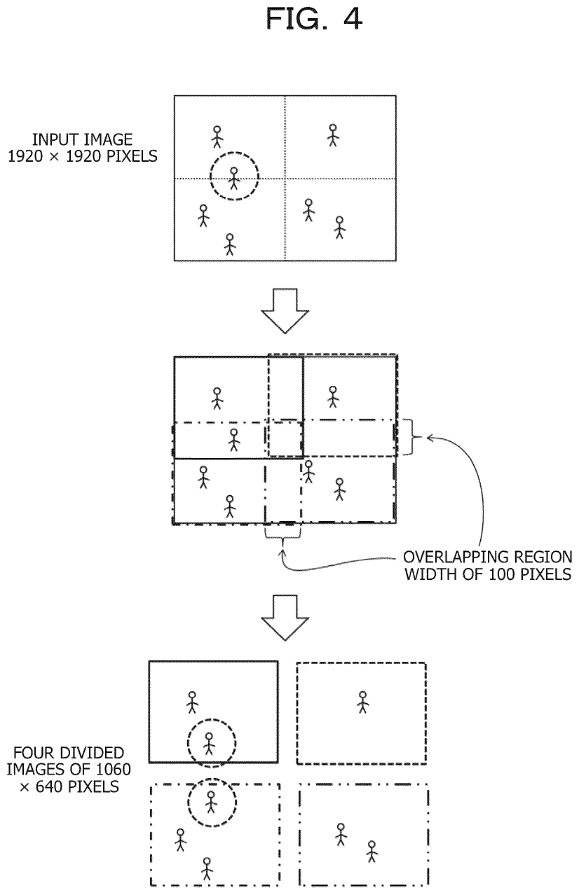

In the case where an input image is divided, there is a possibility that, if an object to be detected is located at a boundary between divided images as illustrated in an upper diagram in FIG. 4 (a broken line portion in the upper diagram of FIG. 4), the object may not be detected from the divided images. To address this, there is a method of dividing an image into divided images redundantly including regions around a division boundary so that an object even located at the boundary between the divided images may be detected. In the middle and lower diagrams of FIG. 4, in the case where an image of 1920×1080 pixels is divided into four, an overlapping region width is set to 100 pixels, and the image is divided into four divided images of 1060×640 pixels. The overlapping regions provided around the division boundary described above make it possible to avoid a situation where an object extends across the boundary as illustrated in a broken line portion in the lower diagram of FIG. 4, and to detect the object from the divided images.

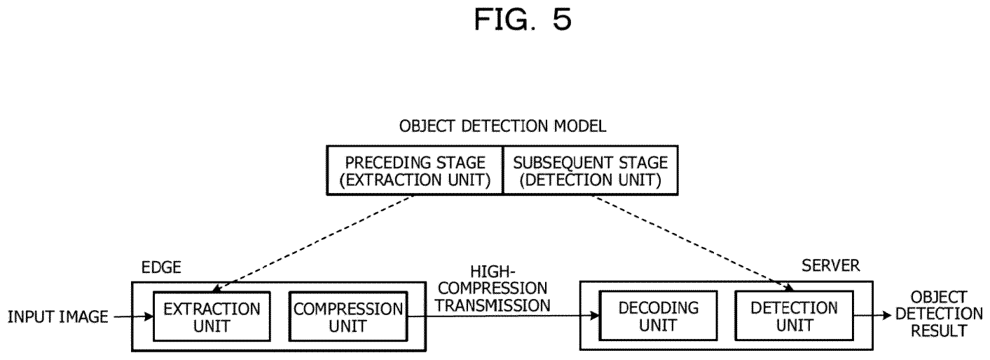

The present embodiments are also based on an image feature compression transmission technique. In the image feature compression transmission technique, an object detection model in YOLOv3 or the like is divided into a preceding stage and a subsequent stage as illustrated in FIG. 5. The preceding stage is an extraction unit that extracts a feature from an image, and the subsequent stage is a detection unit that detects an object based on the feature. As illustrated in FIG. 5, in a more detailed configuration of the image feature compression transmission technique, the extraction unit and a compression unit are arranged in an edge computer (hereafter, also simply referred to as an “edge”), and a decoding unit and the detection unit are arranged in a server. The edge compresses a feature with the compression unit, the feature obtained by inputting an input image to the extraction unit, and transmits the compressed feature to the server. The server receives the compressed feature, decodes the compressed feature with the decoding unit, then performs object detection with the detection unit, and outputs an object detection result. By transmitting a compressed image from the edge while reducing deterioration in object detection accuracy by the object detection model to a certain value, this makes it possible to achieve by far higher compression than in a method in which the server simply performs object detection.

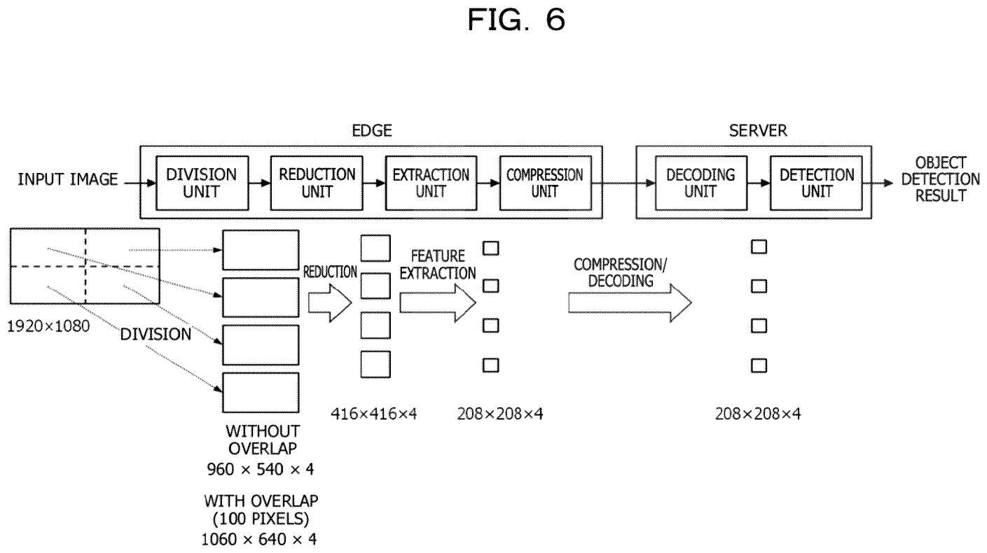

FIG. 6 illustrates an example (hereafter, referred to as a “reference example”) in which the aforementioned method of performing object detection from divided images is applied to the image feature compression transmission technique. As illustrated in FIG. 6, the edge in the reference example includes a division unit, a reduction unit, an extraction unit, and a compression unit, and the server in the reference example includes a decoding unit and a detection unit.

In the example illustrated in FIG. 6, when an input image of 1920×1080 pixels is input, the division unit divides the input image into four divided images. In the case of division without an overlapping region, the size of the divided image is 960×540 pixels. Instead, in the case of division with an overlapping region of, for example, 100 pixels, the size of the divided image is 1060×640 pixels. The reduction unit reduces each of the divided images to an input size (for example, 416×416 pixels) suited to the extraction unit, for example, the preceding stage of YOLOv3. The extraction unit extracts a feature in, for example, a 208×208 size from each of the divided images. The compression unit compresses the feature extracted from each of the divided images and transmits the compressed features to the server. In the server, the decoding unit receives the compressed features and decodes the four features in the 208×208 size, and the detection unit performs object detection from each of the decoded features extracted from the respective divided images, integrates the detection results for the respective divided images, and outputs the integrated detection results as an object detection result for the input image.

In the reference example, a high-resolution image is divided with an overlapping region provided at a division boundary, so that a detection rate of an object located across the division boundary may be increased. However, since the size of the divided image increases by the overlapping region thus added, the processing load for extracting the feature from the divided image increases. Since the processing capacity of the edge is lower than that of the server, an increase in the processing load leads to a decrease in the frame rate of the entire object detection processing.

To address this, each of the following embodiments proposes a method of reducing a processing load on an edge for extracting a feature from an image while providing an overlapping region in dividing an input image as an object detection target, without changing the total size of the input image.

Hereinafter, the embodiments will be described in detail.

### First Embodiment

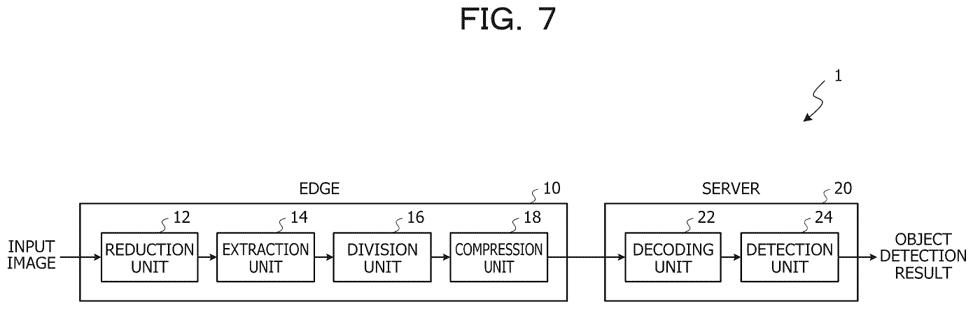

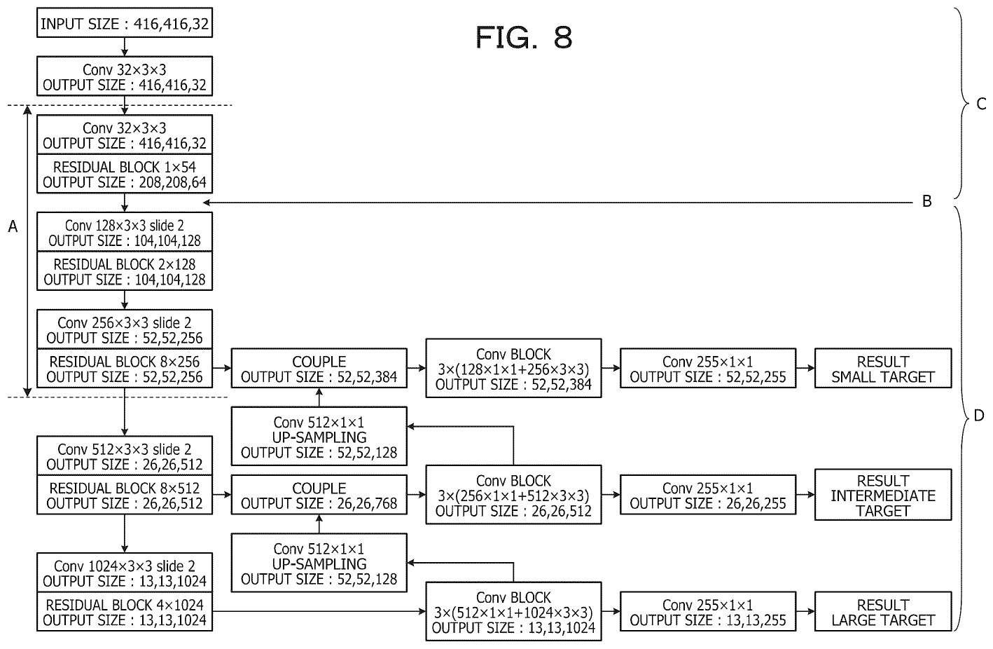

As illustrated in FIG. 7, an object detection system 1 according to a first embodiment includes an edge 10 and a server 20. In the object detection system 1, a preceding stage of an object detection model, which is a deep neural network (for example, YOLO or the like) having multiple intermediate layers, is arranged in the edge 10 and a subsequent stage of the object detection model is arranged in the server 20 as in the reference example described above. In the present embodiment, the division position between the preceding stage and the subsequent stage of the object detection model is set to a position after an intermediate layer which executes processing independent of the image size, such as a fully-connected layer or a connected layer. Since the processing in such an intermediate layer is simple filter processing, the intermediate layer is capable of coping with a size change of an input image without changing a filter coefficient. FIG. 8 illustrates an example of a network structure in a case where an object detection model is YOLOv3. In this case, YOLOv3 may be divided into the preceding stage and the subsequent stage within a range of A in FIG. 8. For example, in the case where YOLOv3 is divided at a position B in FIG. 8, intermediate layers before B form the preceding stage (C in FIG. 8), and intermediate layers after B form the subsequent stage (D in FIG. 8).

A feature that is an output of the preceding stage of YOLOv3 in the case of the above division does not depend on the size of an input image. For example, a result obtained by processing divided images into which an input image is divided is equal to a result obtained by processing the undivided input image. Although the surrounding pixels are different between the above two cases in a strict sense, there is no influence on the results. In order to generate an object detection model for input images different in size, machine learning does not have to be performed on an object detection model for each size of an input image. For this reason, it is possible to generate an object detection model capable of supporting input images different in size by making pixel extension using a network parameter such as an existing filter coefficient so that the object detection model may comply with the size of an image to be input to the preceding stage of the object detection model.

As illustrated in FIG. 7, the edge 10 functionally includes a reduction unit 12, an extraction unit 14, a division unit 16, and a compression unit 18.

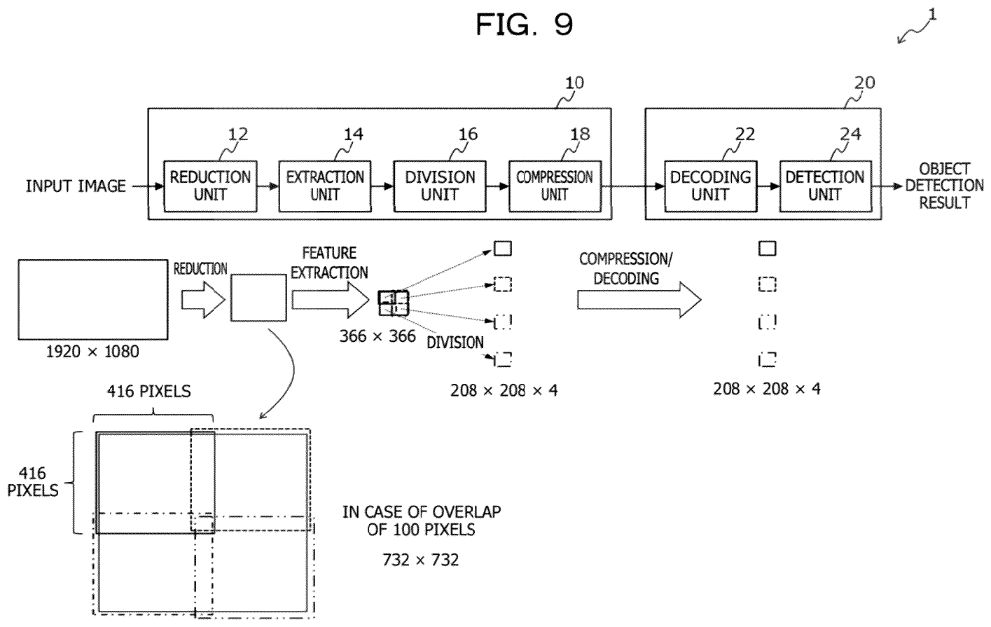

The reduction unit 12 generates a reduced image in which an input image is reduced to a predetermined size. The predetermined size is determined depending on the size of the overlapping region and the size of a divided feature (details will be described later). For example, as illustrated in FIG. 9, in the case where an input image is divided into four, a width of 100 pixels is set as the overlapping region, the size of the divided feature is 208×208, and vertical and horizontal reduction rates in the extraction unit 14 to be described later are 1/2. In this case, the reduction unit 12 reduces the input image to a reduced image of 732×732 pixels. For example, as illustrated in the lower diagram in FIG. 9, the input image is reduced to a size in which four divided images of 416×416 pixels including the overlapping regions with the width of 100 pixels are secured as divided images for four divided features in the size of 208×208. The reduction unit 12 transfers the generated reduced image to the extraction unit 14.

The extraction unit 14 inputs the reduced image to a network at the preceding stage of the object detection model with pixel extension made to comply with the size of the reduced image, and extracts the feature from the reduced image. In the present embodiment, unlike the reference example, the feature is extracted from the overall reduced image instead of extracting the feature from each of the divided images into which the input image is divided. As described above, the reduced image is equivalent to an image in which the divided images for the respective divided features to be described later are overlapped with each other to have the overlapping regions. Accordingly, the extraction unit 14 may extract the same feature as in the case where the features are extracted from the respective divided images, without redundantly executing feature extraction processing for the overlapping regions. The extraction unit 14 transfers the extracted feature to the division unit 16.

The division unit 16 divides the feature transferred from the extraction unit 14 into divided features. The divided feature is equivalent to a feature extracted from each divided image in the case where a reduced image is divided with an overlapping region in a predetermined size. The size of each divided feature is a size depending on a division position in the object detection model, for example, an input size receivable by the detection unit 24 in the subsequent stage of the object detection model. The division unit 16 transfers each of the divided features to the compression unit 18.

The compression unit 18 compresses each of the divided features. The compression unit 18 is an encoder of an autoencoder generated by machine learning so as to compress the divided feature while keeping the divided feature holding information to be used in processing of the detection unit 24 in the subsequent stage. The compression unit 18 transmits each of the compressed divided features to the server 20.

As illustrated in FIG. 7, the server 20 functionally includes a decoding unit 22 and a detection unit 24.

The decoding unit 22 receives each of the compressed divided features transmitted from the edge 10, and decodes each of the compressed divided features. The decoding unit 22 is a decoder of an autoencoder, which is paired with the compression unit 18. The decoding unit 22 transfers each of the decoded divided features to the detection unit 24.

The detection unit 24 inputs each of the decoded divided features to a network at the subsequent stage of the object detection model, and performs object detection from a region of the input image corresponding to the divided image for the divided feature. The detection unit 24 integrates detection results obtained for the respective divided features and outputs the integrated detection results as an object detection result for the input image.

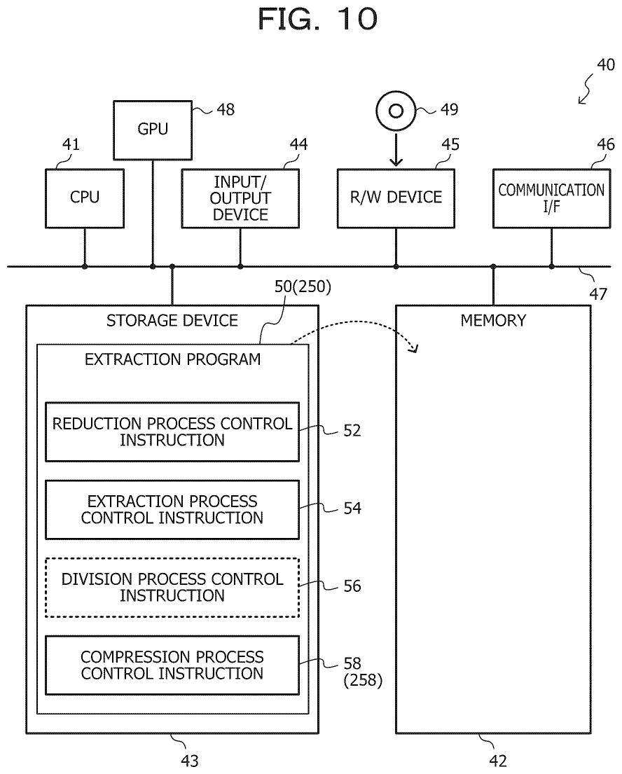

For example, the edge 10 may be implemented by a computer 40 illustrated in FIG. 10. The computer 40 includes a central processing unit (CPU) 41, a graphic processing unit (GPU) 48, a memory 42 serving as a temporary storage area, and a nonvolatile storage device 43. The computer 40 also includes an input/output device 44 such as an input device and a display device, and a read/write (R/W) device 45 that controls reading and writing of data from and to a storage medium 49. The computer 40 also includes a communication interface (I/F) 46 that is coupled to a network such as the Internet. The CPU 41, the memory 42, the storage device 43, the input/output device 44, the R/W device 45, and the communication I/F 46 are coupled to each other via a bus 47.

For example, the storage device 43 is a hard disk drive (HDD), a solid-state drive (SSD), a flash memory, or the like. The storage device 43 serving as a storage medium stores an extraction program 50 for causing the computer 40 to function as the edge 10. The extraction program 50 includes a reduction process control instruction 52, an extraction process control instruction 54, a division process control instruction 56, and a compression process control instruction 58.

The CPU 41 reads the extraction program 50 from the storage device 43, develops the extraction program 50 in the memory 42, and sequentially executes the control instructions included in the extraction program 50. By executing the reduction process control instruction 52, the CPU 41 operates as the reduction unit 12 illustrated in FIG. 7. By executing the extraction process control instruction 54, the CPU 41 operates as the extraction unit 14 illustrated in FIG. 7. By executing the division process control instruction 56, the CPU 41 operates as the division unit 16 illustrated in FIG. 7. By executing the compression process control instruction 58, the CPU 41 operates as the compression unit 18 illustrated in FIG. 7. Consequently, the computer 40 executing the extraction program 50 functions as the edge 10. The CPU 41, which executes the program, is hardware. A part of the processing performed by the CPU 41 may be executed by the GPU 48.

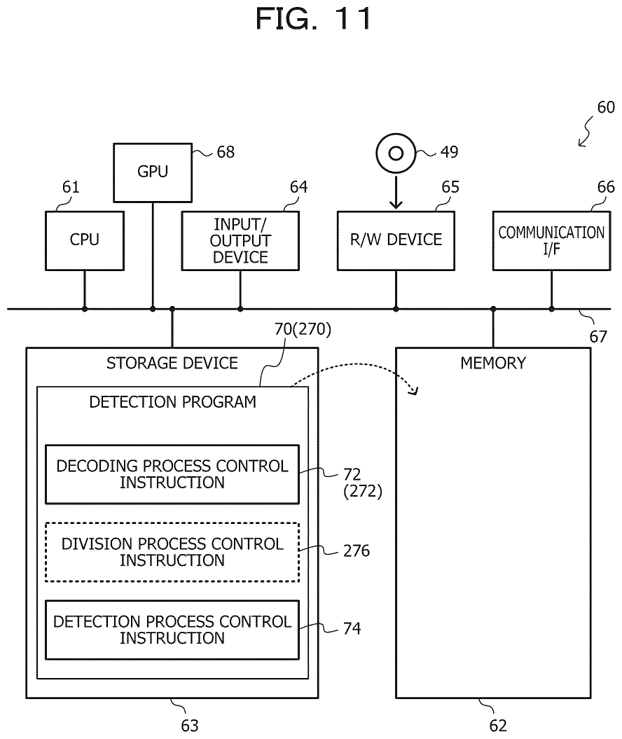

For example, the server 20 may be implemented by a computer 60 illustrated in FIG. 11. The computer 60 includes a CPU 61, a GPU 68, a memory 62, a storage device 63, an input/output device 64, an R/W device 65, and a communication I/F 66. The CPU 61, the memory 62, the storage device 63, the input/output device 64, the R/W device 65, and the communication I/F 66 are coupled to each other via a bus 67.

The storage device 63 serving as a storage medium stores a detection program 70 for causing the computer 60 to function as the server 20. The detection program 70 includes a decoding process control instruction 72 and a detection process control instruction 74.

The CPU 61 reads the detection program 70 from the storage device 63, develops the detection program 70 in the memory 62, and sequentially executes the control instructions included in the detection program 70. By executing the decoding process control instruction 72, the CPU 61 operates as the decoding unit 22 illustrated in FIG. 7. By executing the detection process control instruction 74, the CPU 61 operates as the detection unit 24 illustrated in FIG. 7. Consequently, the computer 60 executing the detection program 70 functions as the server 20. The CPU 61, which executes the program, is hardware.

The functions implemented by each of the extraction program 50 and the detection program 70 may be implemented by, for example, a semiconductor integrated circuit, or more specifically, an application-specific integrated circuit (ASIC), a field-programmable gate array (FPGA), or the like. A part of the processing performed by the CPU 41 or 61 may be executed by the GPU 48 or 68.

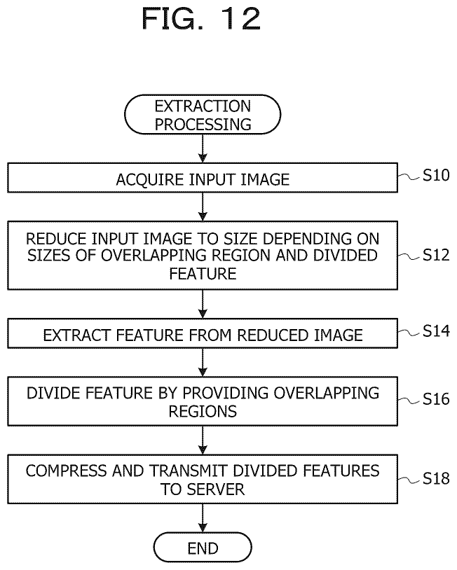

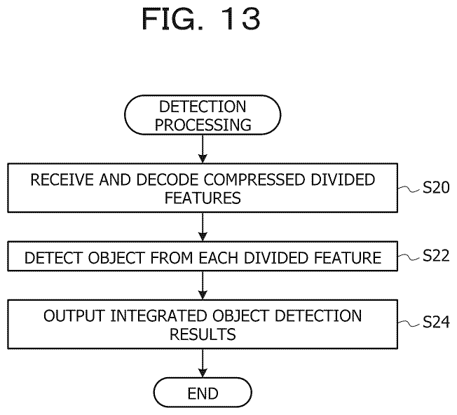

Next, description will be provided for operations of the object detection system 1 according to the first embodiment. When an input image is input to the edge 10, the edge 10 executes extraction processing illustrated in FIG. 12 and the server 20 executes detection processing illustrated in FIG. 13. The extraction processing and the detection processing are an example of the object detection method in the technique disclosed herein.

First, the extraction processing illustrated in FIG. 12 will be described.

In operation S10, the reduction unit 12 acquires an input image. Next, in operation S12, the reduction unit 12 generates a reduced image in which the input image is reduced to a predetermined size determined depending on the size of the overlapping region and the size of the divided feature. Next, in operation S14, the extraction unit 14 inputs the reduced image to the network at the preceding stage of the object detection model with pixel extension made to comply with the size of the reduced image, and extracts the feature from the reduced image.

Next, in operation S16, the division unit 16 divides the feature extracted from the reduced image into divided features equivalent to the features extracted from the respective divided images in the case where the reduced image is divided with the overlapping regions in the predetermined size. Next, in operation S18, the compression unit 18 compresses each of the divided features with the encoder of the autoencoder. The compression unit 18 transmits each of the compressed divided features to the server 20, and the extraction processing ends.

Next, the detection processing illustrated in FIG. 13 will be described.

In operation S20, the decoding unit 22 receives each of the compressed divided features from the edge 10 and decodes each of the compressed divided features with the decoder of the autoencoder. Next, in operation S22, the detection unit 24 inputs each of the decoded divided features to the network at the subsequent stage of the object detection model, and performs object detection from a region of an input image corresponding to the divided image for the divided feature. Next, in operation S24, the detection unit 24 integrates the detection results obtained for the respective divided features and outputs the integrated detection results as an object detection result for the input image, and the detection processing ends.

As described above, in the object detection system according to the first embodiment, an object detection model generated in advance by machine learning in order to detect an object from an image is divided and arranged in the edge computer and the server. The edge computer compresses a feature extracted from an image and transmits the compressed feature to the server, and the server performs object detection based on the decoded feature. The edge computer extracts a feature from a reduced image in which an input image is reduced to a predetermined size determined depending on the size of the overlapping regions and the size of the divided features. The edge computer divides the feature into the divided features in association with respective divided images into which the reduced image is divided with the overlapping regions in the size determined in advance, compresses each of the divided features, and transmits each of the compressed divided features to the server. The server performs object detection for each divided feature in the size depending on the division position in the object detection model, and outputs an object detection result.

In this way, the object detection system according to the present embodiment uses a characteristic that the processing of extracting a feature with an object detection model does not depend on the size of an input image, and thereby extracts the feature from a reduced image to which the input image is reduced, instead of extracting features from respective divided images having the overlapping regions. Because the reduced image is an image in which the overlapping regions of the divided images are superposed on each other, it is possible to avoid redundantly extracting the features from the overlapping regions of the divided images. For example, since the number of pixels in the reduced image is smaller than the number of pixels in the total of the divided images having the overlapping regions, it is possible to reduce the processing load on the edge computer for extracting the feature. As a result, it is possible to achieve speed-up, low latency, and improved processing frame rate of object detection processing.

For example, in the case of the reference example illustrated in FIG. 6, the number of pixels to be processed by the extraction unit is calculated as 416×416 pixels×4=692,224 pixels. For an input image in the same size as in the reference example illustrated in FIG. 6, the number of pixels to be processed by the extraction unit 14 according to the present embodiment is 732×732=535,824 as illustrated in FIG. 9. Accordingly, the processing load may be reduced by about 23% in the present embodiment.

### Second Embodiment

Next, a second embodiment will be described. In an object detection system according to the second embodiment, components similar to those in the object detection system 1 according to the first embodiment will be denoted by the same reference signs and will not be described in detail.

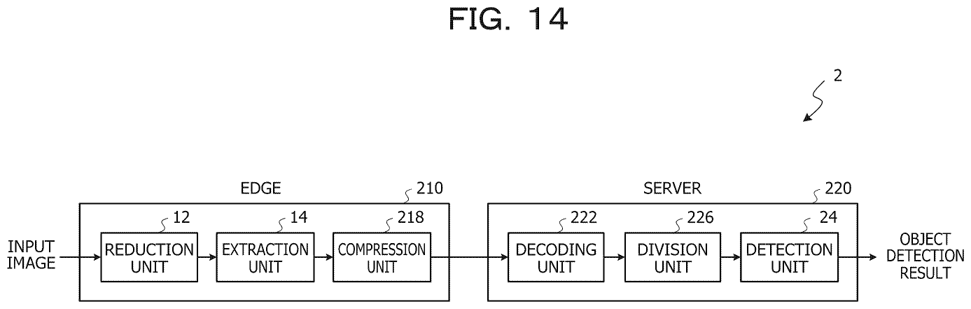

As illustrated in FIG. 14, an object detection system 2 according to the second embodiment includes an edge 210 and a server 220.

As illustrated in FIG. 14, the edge 210 functionally includes a reduction unit 12, an extraction unit 14, and a compression unit 218.

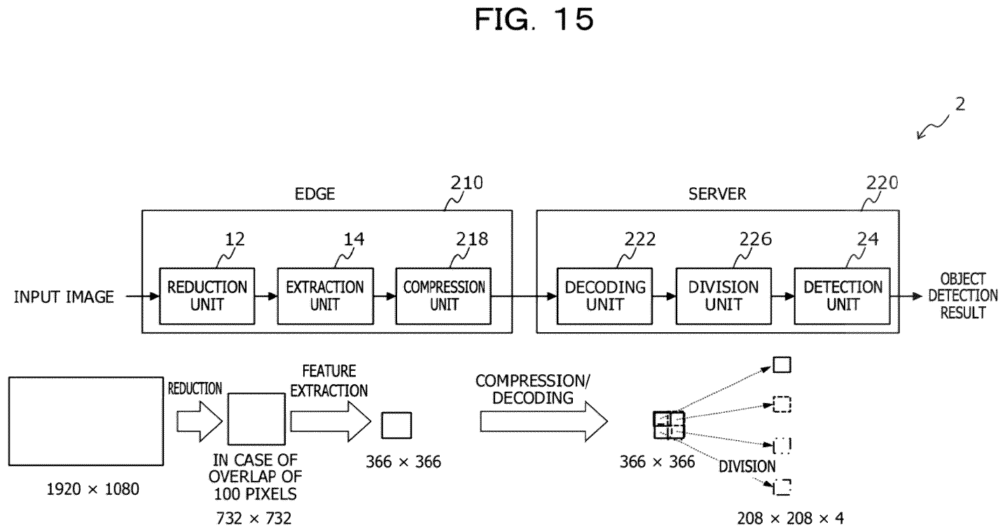

As illustrated in FIG. 15, the compression unit 218 compresses a feature extracted from a reduced image by the extraction unit 14 and transmits the compressed feature to the server 220. To compress the feature, the compression unit 218 uses an encoder of an autoencoder with pixel extension made to comply with the size of the feature to be output from the extraction unit 14.

As illustrated in FIG. 14, the server 220 functionally includes a decoding unit 222, a division unit 226, and a detection unit 24.

The decoding unit 222 receives the compressed feature transmitted from the edge 210, and decodes the compressed feature. To decode the feature, the decoding unit 222 uses a decoder of an autoencoder with pixel extension made to comply with the size of the compressed feature. The decoding unit 222 transfers the decoded feature to the division unit 226.

The division unit 226 divides the feature transferred from the decoding unit 222 into divided features by performing the same processing as in the division unit 16 included in the edge 10 according to the first embodiment. The division unit 226 transfers each of the divided features to the detection unit 24.

For example, the edge 210 may be implemented by the computer 40 illustrated in FIG. 10. The storage device 43 of the computer 40 stores an extraction program 250 for causing the computer 40 to function as the edge 210. The extraction program 250 includes a reduction process control instruction 52, an extraction process control instruction 54, and a compression process control instruction 258.

The CPU 41 reads the extraction program 250 from the storage device 43, develops the extraction program 250 in the memory 42, and sequentially executes the control instructions included in the extraction program 250. By executing the compression process control instruction 258, the CPU 41 operates as the compression unit 218 illustrated in FIG. 14. The other control instructions are the same as those of the extraction program 50 according to the first embodiment. Consequently, the computer 40 executing the extraction program 250 functions as the edge 210. A part of the processing performed by the CPU 41 may be executed by the GPU 48.

For example, the server 20 may be implemented by the computer 60 illustrated in FIG. 11. The storage device 63 of the computer 60 stores a detection program 270 for causing the computer 60 to function as the server 220. The detection program 270 includes a decoding process control instruction 272, a division process control instruction 276, and a detection process control instruction 74.

The CPU 61 reads the detection program 270 from the storage device 63, develops the detection program 270 in the memory 62, and sequentially executes the control instructions included in the detection program 270. By executing the decoding process control instruction 272, CPU 61 operates as the decoding unit 222 illustrated in FIG. 14. By executing the division process control instruction 276, the CPU 61 operates as the division unit 226 illustrated in FIG. 14. By executing the detection process control instruction 74, the CPU 61 operates as the detection unit 24 illustrated in FIG. 14. Consequently, the computer 60 executing the detection program 270 functions as the server 220. A part of the processing performed in the CPU 61 may be executed by the GPU 68.

The functions implemented by each of the extraction program 250 and the detection program 270 may be implemented by, for example, a semiconductor integrated circuit, or more specifically, an ASIC, an FPGA, or the like. A part of the processing performed by the CPU 41 or 61 may be executed by the GPU 48 or 68.

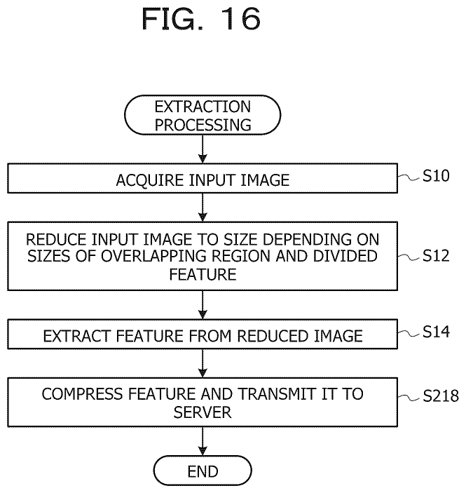

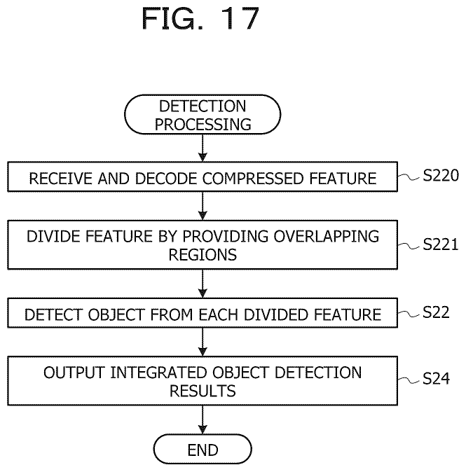

Next, description will be provided for operations of the object detection system 2 according to the second embodiment. When an input image is input to the edge 210, the edge 210 executes extraction processing illustrated in FIG. 16 and the server 220 executes detection processing illustrated in FIG. 17. In the extraction processing and the detection processing according to the second embodiment, the same processing as in the extraction processing and the detection processing according to the first embodiment will be denoted with the same operation number and will not be described in detail.

First, the extraction processing illustrated in FIG. 16 will be described.

In operation S218 after execution of operations S10 to S14, the compression unit 218 compresses the feature extracted in the above-described operation S14 with the encoder of the autoencoder with pixel extension made to comply with the size of the feature to be output from the extraction unit 14. The compression unit 218 transmits the compressed feature to the server 220, and the extraction processing ends.

Next, the detection processing illustrated in FIG. 17 will be described.

In operation S220, the decoding unit 222 receives the compressed feature from the edge 210, and decodes the compressed feature with the decoder of the autoencoder. Next, in operation S221, the division unit 226 divides the decoded feature into divided features. After execution of operations S22 and S24, the detection processing ends.

As described above, in the object detection system according to the second embodiment, the edge computer extracts a feature from a reduced image in which an input image is reduced to a predetermined size determined depending on the size of the overlapping region and the size of the divided feature, compresses the feature, and transmits the compressed feature to the server. The server decodes the compressed feature, divides the feature into divided features, performs object detection from each of the divided features, and outputs an object detection result. Since the division processing of the feature is not performed on the edge side, it is possible to further reduce the processing load on the edge side. The data volume in the case where the feature of the reduced image is compressed is smaller than in the case where all the divided features of the multiple divided images divided redundantly with the overlapping regions are compressed, which also leads to a reduction in the network band between the edge and the server. Since the features to be processed in the compression unit and the decoding unit are also reduced, the processing loads on the compression unit and the decoding unit may be reduced.

Although each of the above-described embodiments has been described mainly by using the example in the case where the object detection model is YOLOv3, embodiments are not limited to this. An object detection model may be any network by deep learning including an intermediate layer in the preceding stage that does not depend on the size of an input image, such as an intermediate layer which simply performs filter processing.

Although the extraction program and the detection program are stored (installed) in the storage device in advance in each of the above-described embodiments, embodiments are not limited to this. The programs according to the technique disclosed herein may be provided in a form of being stored in a storage medium such as a compact disc read-only memory (CD-ROM), a Digital Versatile Disc ROM (DVD-ROM), a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An object detection system configured to form an object detection model generated by machine learning to detect an object from an image, the object detection system comprising:
an edge computer configured to
extract a feature from a reduced image in which an input image is reduced to a predetermined size, and
compress and transmit the feature; and
a server configured to
decode the feature, and
perform object detection for each of divided features into which the feature is divided in association with respective divided images into which the reduced image is divided with overlapping regions in a first size, the divided features including a second size that depends on a division position in the object detection model,
wherein the predetermined size is determined based on the first size of the overlapping regions and the second size of the divided features, and
wherein the object detection model is divided into the edge computer and the server.

2. The object detection system according to claim 1,
wherein the edge computer divides the feature extracted from the reduced image into the divided features, compresses each of the divided features, and transmits each of the compressed divided features to the server, and
wherein the server decodes each of the compressed divided features, and performs object detection based on each of the decoded divided features.

3. The object detection system according to claim 1,
wherein the edge computer compresses the feature extracted from the reduced image and transmits the compressed feature to the server, and
wherein the server decodes the compressed feature, divides the decoded feature into the divided features, and performs object detection based on each of the divided features.

4. The object detection system according to claim 1,
wherein the object detection model is a deep neural network which includes a plurality of intermediate layers, and
wherein the second size is a size of a feature to be input to an intermediate layer after the division position in the object detection model which is divided and arranged in the edge computer and the server.

5. The object detection system according to claim 4, wherein the edge computer extracts the feature from the reduced image by using an intermediate layer included in the object detection model, the intermediate layer performing image filter processing.

6. The object detection system according to claim 4, wherein a preceding stage of the object detection model divided at any position between intermediate layers which perform the image filter processing is arranged in the edge computer, and a subsequent stage of the object detection model is arranged in the server.

7. An object detection method of an object detection system configured to form an object detection model generated by machine learning to detect an object from an image, the object detection method comprising:
extracting a feature from a reduced image in which an input image is reduced to a predetermined size; and
compressing and transmitting the feature; by an edge computer, and
decoding the feature; and
performing object detection for each of divided features into which the feature is divided in association with respective divided images into which the reduced image is divided with overlapping regions in a first size, the divided features including a second size that depends on a division position in the object detection model, by a server,
wherein the predetermined size is determined based on the first size of the overlapping regions and the second size of the divided features, and
wherein the object detection model is divided into the edge computer and the server.

8. The object detection method according to claim 7,
wherein the edge computer divides the feature extracted from the reduced image into the divided features, compresses each of the divided features, and transmits each of the compressed divided features to the server, and
wherein the server decodes each of the compressed divided features, and performs object detection based on each of the decoded divided features.

9. The object detection method according to claim 7,
wherein the edge computer compresses the feature extracted from the reduced image and transmits the compressed feature to the server, and
wherein the server decodes the compressed feature, divides the decoded feature into the divided features, and performs object detection based on each of the divided features.

10. The object detection method according to claim 7,
wherein the object detection model is a deep neural network which includes a plurality of intermediate layers, and
wherein the second size is a size of a feature to be input to an intermediate layer after the division position in the object detection model which is divided and arranged in the edge computer and the server.

11. The object detection method according to claim 10, wherein the edge computer extracts the feature from the reduced image by using an intermediate layer included in the object detection model, the intermediate layer performing image filter processing.

12. The object detection method according to claim 10, wherein a preceding stage of the object detection model divided at any position between intermediate layers which perform the image filter processing is arranged in the edge computer, and a subsequent stage of the object detection model is arranged in the server.
